(19) United States
(12) Patent Application Publication
(10) Pub. No.: US 2013/0010959 A1
(43) Pub. Date: Jan. 10, 2013

(54) DATA BACKUP DEVICE FOR SMARTPHONE

(76) Inventor: Sheng-Yuan SHIH, Taipei City (TW)

(21) Appl. No.: 13/472,957

(22) Filed: May 16, 2012

(30) Foreign Application Priority Data
Jul. 5, 2011 (TW) 100212250

(51) Int. Cl. G06F 17/30; G06F 1/26; H04K 1/02; H04W 4/00

(52) U.S. Cl. 380/270; 707/654; 455/419; 713/300; 707/E17.005

(57) ABSTRACT

A data backup device for a Smartphone is provided. When a user electrically connects the Smartphone with a connection interface of the device, a control unit of the device is activated to execute a backup program stored in a program storage unit of the device. After the user inputs a username and a password, the backup program generates a backup folder corresponding to the input username. Then, the user selects different modes of the backup program, so that the data backup device can execute the data backup or data recovery.

### BACKGROUND OF THE INVENTION

a) Field of the Invention

The present invention relates to a data backup device for a Smartphone, and in particular to a device for backing up the data stored in a Smartphone.

b) Description of the Prior Art

Since the Smartphone becomes popular and versatile, more and more users like web-surfing, taking pictures, listening music, watching videos and sharing information via the Smartphone. Although the Smartphone significantly increases the convenience in our daily life, protecting the data privacy of the user becomes an important issue as more data is stored in the Smartphone.

The current operating systems of the Smartphone can be divided into two categories: iOS (iPhone OS) developed by Apple Inc. and Android system developed by Google. Since the data stored in the iOS and the data stored in the Android system cannot be used in common, as a result dedicated application programs need to be developed respectively for these two different operating systems.

Since the storage capacity of the existing Smartphone is greater than 16 Gigabytes (GB), the capacity seems enough for a lot of Smartphone users for now, therefore, many users if not necessary do not have the habit of sorting or deleting data in the Smartphone on a regular basis. The risk of not backing up data regularly is that if user loses his/her Smartphone or sends it for repair, the data stored in the Smartphone may be divulged or totally lost.

Although the two systems (iOS and Android) provide backup programs respectively, if several users intend to backup the data of their Smartphones in one computer, the data backup may be performed erroneously among these Smartphones. In order to solve this problem, each Smartphone user has to buy his/her own computer for backing up the data in his/her Smartphone, which makes the data backup inconvenient and raises economic burden for the user.

### SUMMARY OF THE INVENTION

An objective of the present invention is to provide a data backup device for a Smartphone, in which a data storage unit is provided to backup the data of the same Smartphone into several copies.

In order to achieve the above objective, the present invention provides a data backup device for a Smartphone, which includes: a control unit acting as a processing unit and providing signal communications among respective units; a program storage unit storing a driver for a computer and a backup program for the Smartphone, the program storage unit being configured to receive instructions from the control unit and to operate based on the instructions of the control unit; a connection interface electrically connected to the Smartphone and configured as a communication interface between the data backup device and the Smartphone or a computer; a data storage unit configured to receive the instructions from the control unit and to store digital data; a power supply unit configured to supply necessary electricity to the data backup device and electrically connected the control unit; a control switch electrically connected to the power supply unit for turning on/off the data backup device; a display unit electrically connected to the control unit for receiving signals from the control unit and displaying an operating state of the data backup device.

When the data backup device of the present invention is used to backup the data in the Smartphone, the Smartphone is first electrically connected to the data backup device of the present invention via the connection interface. Then, the data backup device sends a signal to the Smartphone and identifies an operating system used in the Smartphone. Thereafter, the data backup device transmits the backup program to the Smartphone, so that the Smartphone is activated to execute the backup program. At this time, the user is required to input a username and a password. After the user inputs the correct username and password, the data backup device automatically generates a backup folder corresponding to the username. The data originally stored in the Smartphone is successfully backed up into the backup folder. When the user intends to backup the data next time and inputs the same correct username and password, the data backup device can generate another backup folder having the current date in the previous backup folder corresponding to the username. In this way, the user can backup the data into several copies.

Another object of the present invention is to provide a data backup device for a Smartphone, which is capable for recovering the data from the data backup device to the Smartphone.

In order to achieve the above objective, the basic construction of the data backup device of the present embodiment is substantially the same as that in the previous embodiment, so that the redundant description is omitted for clarity. Only the difference will be described as follows. The data recovery is performed by a recovery mode of the backup program. When the user intends to recover the data back to the Smartphone, he/she has to electrically connect the Smartphone with the connection interface of the data backup device. When the data recovery is to be performed, the procedure of the data recovery is as follows. The data backup device sends a signal to the Smartphone and identifies an operating system used by the Smartphone. After the Smartphone is activated to execute the backup program, the user is required to input a username and a password. After the user inputs the correct username and password, the backup program automatically find a folder corresponding to the username. The backup program is capable of overwriting the data of the correct folder into the Smartphone, thereby completing the data recovery.

A further object of the present invention is to provide a data backup device for a Smartphone, which is capable of deleting the data in the Smartphone completely after data backup.

In order to achieve the above objective, the basic construction of the data backup device of the present embodiment is substantially the same as that in the previous embodiments, so that the redundant description is omitted for clarity. Only the difference will be described as follows. The data deletion is performed by a repair mode of the backup program. When the user needs to send his/her Smartphone for sale or repair, the data originally stored in the Smartphone can be backed up by using the repair mode of the data backup device of the present invention. First, the Smartphone is electrically connected to the data backup device. Then, the data backup device sends a signal to the Smartphone and identifies an operating system used in the Smartphone. The Smartphone is activated to execute the backup program. The user inputs a username and a password. After the user inputs the correct username and password, the backup program automatically find a folder corresponding to the input username. The user tips the Smartphone to select the repair mode. At this time, the data backup device is activated to backup the data originally stored in the Smartphone into the data backup device. After completing the data backup, the data backup device deletes the data originally stored in the Smartphone to finish the repair mode.

### BRIEF DESCRIPTION OF THE DRAWINGS

FIG. 1 is a block view showing the construction of the present invention;

FIG. 2 is a block view showing the function of the backup program of the present invention;

FIG. 3 is a flow chart showing the procedure of a data backup mode of the present invention;

FIG. 4 is a flow chart showing the procedure of a data recovery mode of the present invention;

FIG. 5 is a flow chart showing the procedure of a repair mode of the present invention;

FIG. 6 is a flow chart showing the procedure of an update mode of the present invention; and

FIG. 7 is a block view showing a data-browsing process of the present invention.

### DETAILED DESCRIPTION OF THE PREFERRED EMBODIMENTS

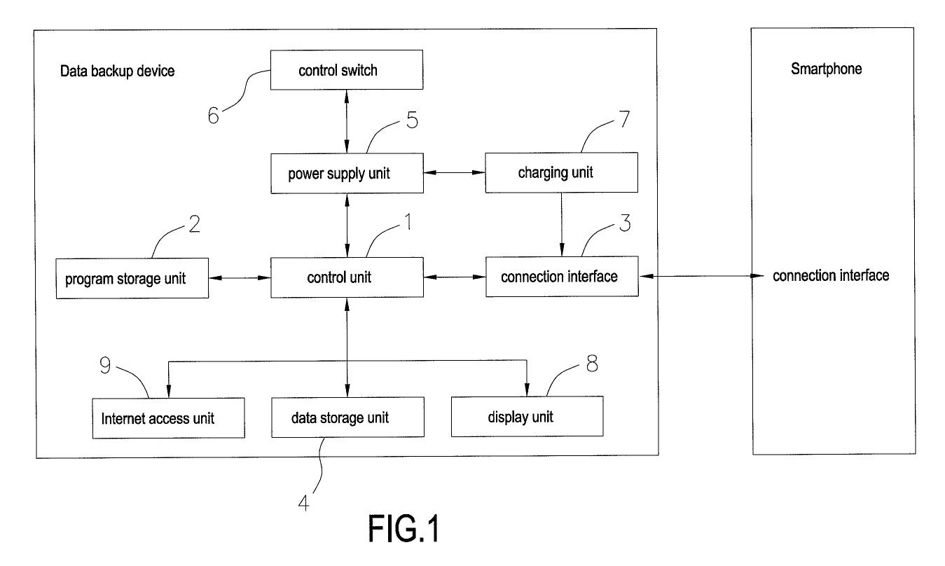

Please refer to FIG. 1, which is a block view showing the construction of the present invention. The present invention provides a data back device for a Smartphone, which includes a control unit 1, a program storage unit 2, a connection interface 3, a data storage unit 4, a power supply unit 5, a control switch 6, a charging unit 7, a display unit 8, and an Internet access unit 9.

The control unit 1 is configured as a processing core of the data backup device of the present invention and provides signal communications among the respective units. The control unit 1 may be configured as a microprocessor like a central processing unit (CPU), a micro-controller (Micron), a digital signal processor (DSP), an application-specific integrated circuit (ASIC), or a programmable logic circuit (PLD, CPLD, FPGA). The most common control unit 1 is a microprocessor (CPU). The control unit 1 is configured to generate a simplex or multiplex operation.

The program storage unit 2 is configured to store a driver for a computer and a backup program for the Smartphone. The backup program may be executed in the Windows or Linux System. The backup program receives instructions from the control unit 1 and operates based on the instructions of the control unit 1. The backup program is constituted of commands or program codes. The backup program comprises a data backup mode, a data recovery mode, a repair mode, and an update mode. The program storage unit 2 may be configured as a flash memory or an electrically-erasable programmable read-only memory (EEPROM, ROM). The backup program can store and record the operating state of the data backup device, such as access time, the number of times. More specifically, the backup program is Log files in the computer.

The connection interface 3 is electrically connected to the control unit 1 for receiving the signals from the control unit 1. The connection interface 3 is used as a communication interface between the data backup device of the present invention and the Smartphone or the computer. The connection interface 3 is configured as an electrical connector such as a Micro USB (Universal Serial Bus) or a Mini USB.

The data storage unit 4 is electrically connected to the control unit 1 and the display unit 8. The data storage unit 4 is configured to receive the instructions from the control unit 1 to store digital data. The data storage unit 4 may be configured as a hard disk or a solid state disk.

The power supply unit 5 is configured to provide the necessary electricity to the data backup device of the present invention and is electrically connected to the control unit 1. The power supply unit 5 may be configured as a built-in battery or an internal power source.

The control switch 6 is electrically connected to the power supply unit 5. The user turns on or off the data backup device of the present invention via the control switch 6. The control switch 6 may be configured as a DIP switch or a button switch.

The charging unit 7 is electrically connected to the power supply unit 5 and the connection interface 3. The charging unit 7 is configured to convert a voltage or electric current supplied by the power supply unit 5 into a voltage or electric current suitable for the Smartphone, whereby the Smartphone can be charged via the connection interface 3.

The display unit 8 is electrically connected to the control unit 1 for receiving the signals from the control unit 1 and displaying the operating state of the data backup device of the present invention. The display unit 8 may be configured as a LED (Light Emitting Diode) panel or a liquid crystal display (LCD). The operating state of the data backup device of the present invention is displayed by the display unit 8.

The Internet access unit 9 is electrically connected to the data storage unit 4 and the control unit 1. The Internet access unit 9 may be configured as a wireless antenna. The Internet access unit 9 is configured to store the data downloaded from the Internet into the data storage unit 4 and the downloaded data can be controllably used by the control unit 1. Further, the Internet access unit 9 may be electrically connected to the Smartphone via wireless signals and the control unit 1. In this way, the data backup device of the present invention can be wirelessly connected to the Smartphone, so that data can be transmitted there between. Moreover, when the data backup device of the present invention is wirelessly connected to the Smartphone, the wireless signals can be encrypted before transmission. The encryption is achieved by adding plain codes in the signals or encoding the signals via the control unit 1 before transmission, thereby preventing the data from being stolen or improperly accessed by other Smartphone.

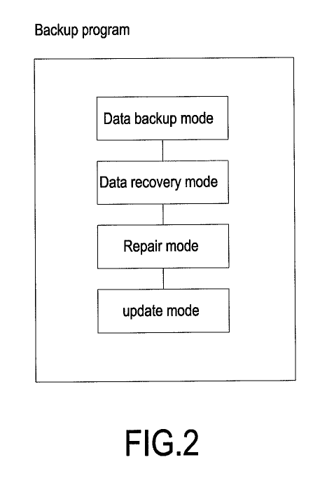

Please refer to FIG. 2, which is a schematic view showing the function of the backup program of the present invention. The backup program of the present invention includes a data backup mode, a data recovery mode, a repair mode, and an update mode. The user can tip the Smartphone to select a desired mode among the above built-in modes. In the following, three different modes will be described.

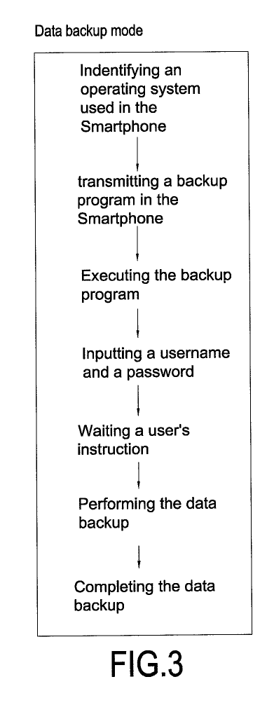

Please refer to FIG. 3, which is a flow chart showing the procedure of the data backup mode of the present invention. When the user electrically connects the connection interface of the Smartphone to the connection interface of the data backup device of the present invention and intends to backup the data, the data backup procedure is as follows.

In a step 1, the data backup device of the present invention sends a signal to the Smartphone and identifies an operating system used in the Smartphone.

In a step 2, the data backup device of the present invention transmits the backup program into the Smartphone.

In a step 3, the Smartphone receives the backup program and executes it.

In a step 4, the user inputs a username and a password. Thereafter, the data backup device will automatically generate a backup folder corresponding to the input username.

In step 5, the user selects the data backup mode. At this time, the data backup device of the present invention can backup the data stored in the Smartphone into the backup folder, thereby completing the data backup.

During the data backup, the data backup device of the present invention displays the current conditions of the data backup via the display unit, whereby the user can understand the progress of the data backup device of the present invention. The data backup device of the present invention can perform the data backup of one Smartphone or several Smartphones via the control unit. More specifically, the control unit generates a multiplex operation to achieve the data back of several Smartphones simultaneously.

After the data backup, when the user intends to backup the data again and thus he/she inputs the same username and password, the data backup device of the present invention can generate another backup folder having the current date in the previous backup folder corresponding to the input username. In this way, the user can backup the data into several copies. For example, if the backup folder is named as “ABC”, another new backup folder named as “20120101” will be generated in the previous backup folder named as “ABC”, thereby generating several copies of the data.

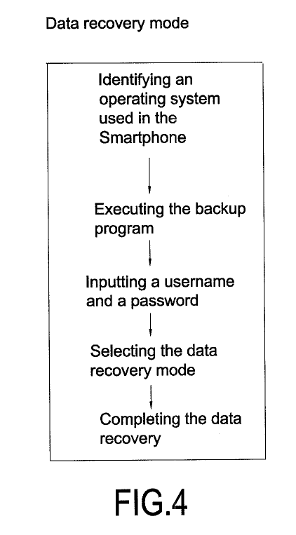

Please refer to FIG. 4, which is a schematic view showing the procedure of the data recovery mode of the present invention. When the user intends to recover the data back to the Smartphone, the user electrically connects the Smartphone to the connection interface of the data backup device of the present invention. The procedure of the data recovery mode is described as follows:

In a step 1, the data backup device of the present invention sends a signal to the Smartphone and identifies an operating system used in the Smartphone.

In a step 2, the Smartphone executes the backup program.

In a step 3, the user inputs a username and a password. After the username and password are input, the backup program will automatically search a folder corresponding to the input username.

In a step 4, the user tips the Smartphone to select the data recovery mode. The backup program will automatically overwrite the data of the folder into the Smartphone, thereby completing the data recovery.

During the data recovery, the data backup device of the present invention will display the real-time conditions of the data recovery on the display unit, so that the user can understand the progress the data backup device of the present invention.

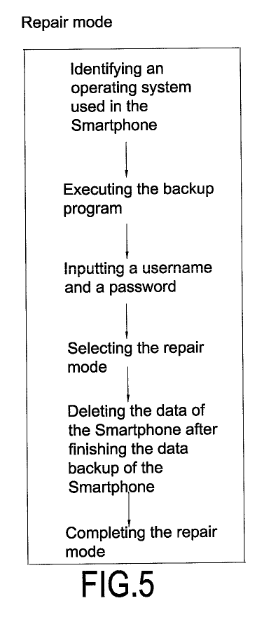

Please refer to FIG. 5, which is a schematic view showing the procedure of the repair mode of the present invention. When the user needs to send his/her Smartphone for sale or repair, the user can backup the data stored in his/her Smartphone by using the repair mode of the data backup device of the present invention. The procedure of the repair mode of the present invention is as follows.

In a step 1, the data backup device of the present invention sends a signal to the Smartphone and identifies an operating system used in the Smartphone.

In a step 2, the Smartphone is activated to execute the backup program.

In a step 3, the user inputs a username and a password. After the username and password are input, the backup program automatically finds a folder corresponding to the input username.

In a step 4, the user tips the Smartphone to select the repair mode.

In a step 5, the data stored in the Smartphone is backed up in the data backup device of the present invention. After finishing the data backup, the data backup device of the present invention will delete the data stored in the Smartphone completely.

In a step 6, the repair mode is completed.

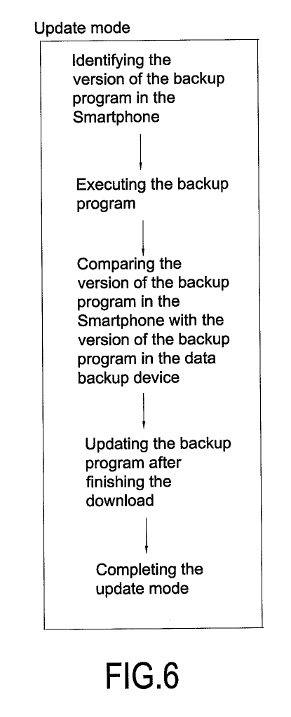

Please refer to FIG. 6, which is a schematic view showing the procedure of the update mode of the present invention. When the user uses his/her Smartphone to download the latest backup program via the Internet, the original backup program or even the firmware stored in the data backup device will be updated. The procedure of the update mode is as follows.

In a step 1, the data backup device of the present invention sends a signal to the Smartphone and indentifies an operating system used in the Smartphone.

In a step 2, the Smartphone is activated to execute the backup program.

In a step 3, the backup program compares the latest version of the backup program download in the Smartphone with the original version of the backup program stored in the data backup device.

In a step 4, if the version of the backup program in the Smartphone is newer than the version of the backup program in the data backup device, the data backup device of the present invention will download the newer backup program from the Smartphone. After finishing the download, the data backup device will be updated.

In a step 5. the update mode is completed.

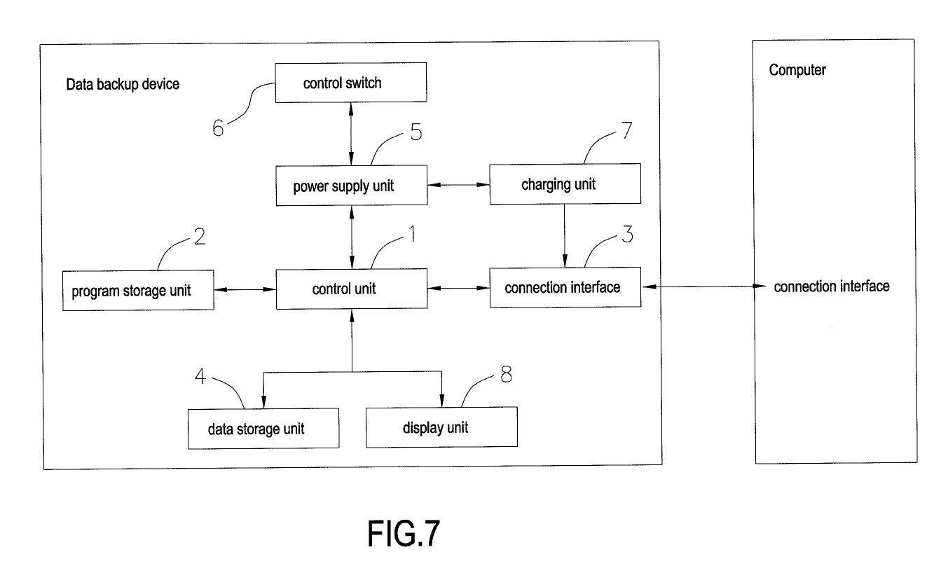

Please refer to FIG. 7, which is a block view showing the data-browsing process of the present invention. When the user intends to copy or delete the data backed up in the computer, the user electrically connects the connection interface 3 of the data backup device to the connection interface of the computer. For example, the user can use a connecting line having a Micro USB at one end and a USB at the other end to electrically connect the data backup device to the computer. After the data backup device is electrically connected to the computer, the data backup device executes a driver to the computer, so that the computer can identify the data backup device. After the data backup device identifies the operating system of the system, the data backup device executes the backup program and requires the user to input a username and a password. When the user inputs a correct username and password via the computer, the user can access the data backup device. At this time, the user can see the contents in a folder corresponding to the input username, so that the user can copy or delete the data in the data backup device, and protect the data from being improperly accessed by others.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A data backup device for a Smartphone, including:
a control unit, configured as an operation micro-processor for providing signal communication between respective units;
a program storage unit, configured as a memory and electrically connected to the control unit, the program storage unit being configured to store a driver for a computer and a backup program for the Smartphone and to receive instructions from the control unit, the backup program comprising a data backup mode and a data recovery mode, the backup program requiring a user to input a username and a password so as to execute a data backup or data recovery process;
a connection interface, configured as a connector for receiving a signal from the control unit and transmitting a signal from the Smartphone or a computer into the control unit;
a data storage unit, configured as a hard disk for receiving the instructions from the control unit and storing digital data;
a power supply unit, electrically connected to the control unit for providing necessary electricity to the whole data backup device; and
a display unit, configured to receive the signal from the control unit and display an operating state of the data backup device,
wherein different users inputs respective usernames and passwords to administer their own data backup so as to backup the data of different Smartphones.

2. The data backup device for a Smartphone according to claim 1, wherein the power supply unit is electrically connected to a control switch, the user can turn on or off the data backup device via the control switch, the control switch is configured as a button switch or a DIP switch.

3. The data backup device for a Smartphone according to claim 1, wherein a charging unit is electrically connected between the power supply unit and the connection interface, the charging unit is configured to convert a voltage or electric current supplied by the power supply unit into a voltage or electric current suitable for the Smartphone, thereby charging the Smartphone via the connection interface.

4. The data backup device for a Smartphone according to claim 1, wherein the data backup mode of the backup program includes steps of:
sending a signal to the Smartphone and indentifying an operating system used in the Smartphone;
transmitting the backup program to the Smartphone;
executing the backup program after the Smartphone receives the backup program;
inputting a username and a password, so that the data backup device can automatically generate a backup folder corresponding to the input username; and
selecting the backup mode, so that the data backup device can backup the data of the Smartphone into the backup folder, thereby completing the data backup.

5. The data backup device for a Smartphone according to claim 1, wherein the data recovery mode of the backup program includes steps of:
sending a signal to the Smartphone and identifying an operating system used in the Smartphone;
executing the backup program via the Smartphone;
inputting a username and a password, so that the backup program can automatically find a folder corresponding to the input username; and
selecting the data recovery mode from the Smartphone, so that the backup program can automatically overwrite the data of the folder into the Smartphone, thereby completing the data recovery.

6. The data backup device for a Smartphone according to claim 1, wherein the backup program further comprises a repair mode.

7. The data backup device for a Smartphone according to claim 6, wherein the repair mode of the backup program includes steps of:
sending a signal to the Smartphone and identifying an operating system used in the Smartphone;
executing the backup program via the Smartphone;
inputting a username and a password, so that the backup program can automatically find a folder corresponding to the input username;
selecting the repair mode from the Smartphone;
backing up the data of the Smartphone in the data backup device and deleting the data completely in the Smartphone after finishing the data backup; and
completing the repair mode.

8. The data backup device for a Smartphone according to claim 1, wherein the backup program further comprises an update mode.

9. The data backup device for a Smartphone according to claim 8, wherein the update mode of the backup program includes steps of:
sending a signal to the Smartphone and identifying an operating system used in the Smartphone;
executing the backup program via the Smartphone;
comparing the version of the backup program in the data backup device with the version of the backup program in the Smartphone;
downloading the backup program of the Smartphone into the data backup device if the backup program of the Smartphone is newer than the backup program of the data backup device, updating the backup program after finishing the download; and
completing the update mode.

10. The data backup device for a Smartphone according to claim 1, wherein the control unit and the data storage unit are electrically connected to an Internet access unit, the internet access unit is configured as a wireless antenna for storing data downloaded from the Internet into the data storage unit, and the downloaded data is controllably used by the control unit.

11. The data backup device for a Smartphone according to claim 10, wherein the Internet access unit is wirelessly connected to the Smartphone, the Internet access unit encrypts wireless signals before transmission, the encryption is achieved by adding plain codes into the signals or encoding the signals via the control unit before transmission, thereby preventing the data in the Smartphone from being stolen or improperly accessed by other Smartphone.
